(19) United States
(12) Patent Application Publication
(10) Pub. No.: US 2011/0308397 A1
(43) Pub. Date: Dec. 22, 2011

(54) ASSEMBLY, PACKAGE AND APPARATUS FOR PREPARING A BEVERAGE

(75) Inventors: Sander Jeroen Sinot, Laren (NL); Paul Costerus, Amersfoort (NL); Walter Pieter Louwerse, Hilversum (NL)

(73) Assignee: Vital Products B.V., EX Laren (NL)

(21) Appl. No.: 13/055,197

(22) PCT Filed: Jul. 21, 2008
(86) PCT No.: PCT/EP2008/059514

§ 371 Date: Mar. 29, 2011

(51) Int. Cl. A47J 31/40

(52) U.S. Cl. 99/283; 99/295

(57) ABSTRACT

An assembly for preparing a beverage comprises a concentrate containing package and an apparatus for receiving the package and for preparing a beverage with the concentrate. The apparatus comprises a recess for receiving said package, a concentrate discharge channel debouching in said recess and connecting to a mixing chamber, and movable pressure element for pressurizing the package. The package rupturing mechanism is positioned in said concentrate discharge channel in a manner as not to protrude effectively into the recess. The package is sufficiently flexible as to bulge out locally towards the concentrate discharge channel and into contact with the package rupturing mechanism when pressurized by the pressure element. Further a package and an apparatus for use in the assembly are provided.

### CROSS-REFERENCE TO RELATED APPLICATION

This application is a Section 371 National Stage Application of International Application PCT/EP2008/059514 filed Jul. 21, 2008 and published as WO/2010/009753 in English.

### BACKGROUND

The discussion below is merely provided for general background information and is not intended to be used as an aid in determining the scope of the claimed subject matter.

An aspect of the invention firstly relates to an assembly for preparing a beverage. Known assemblies of such type comprise a package comprising a concentrate for preparing a beverage, and an apparatus for receiving therein said package, open the package and leading its contents into a mixing chamber in which the beverage is prepared by mixing the concentrate with water. The prepared beverage then is dispensed through a dispensing channel into a receptacle.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

An assembly for preparing a beverage includes a concentrate containing package and an apparatus for receiving the package and for preparing a beverage with the concentrate, wherein said apparatus comprises a recess for receiving said package, a concentrate discharge channel debouching in said recess and connecting to a mixing chamber, and movable pressure element for pressurizing the package, wherein a package rupturing mechanism is positioned in said concentrate discharge channel in a manner as not to protrude effectively into the recess and wherein the package is sufficiently flexible as to bulge out locally towards the concentrate discharge channel and into contact with the package rupturing mechanism when pressurized by the pressure element.

Because of the position of the package rupturing mechanism within the concentrate discharge channel without effectively protruding therefrom into the recess, the risk of an unintentional rupturing of the package or the risk of injuries to a user of the apparatus is minimized. Only when the package is pressurized sufficiently by the pressure element, it can deform such (due to its flexible nature) that it contacts the package rupturing mechanism such that it can rupture the package as a result of which its contents (the concentrate) flows through the concentrate discharge channel towards the mixing chamber. The material of which the package is made should be flexible enough to allow such a deformation/bulging out. It is within the reach of persons skilled in the relevant art to choose such materials which are available on the market.

It is noted that the phrase “in a manner as not to protrude effectively into the recess” tries to express that it is within the scope of the present invention that the package rupturing mechanism projects slightly from the concentrate discharge channel, however not sufficiently far for rupturing the package or for injuring a user.

In an embodiment of the assembly, the package rupturing mechanism does not protrude at all into the recess and the package will bulge out into the concentrate discharge channel when pressurized by the pressure element.

Such an embodiment offers the best protection against unintentionally rupturing the package or against injuries.

When, in accordance with another embodiment of the assembly, the concentrate discharge channel is provided in a lower wall of the recess, the outflow of concentrate, once the package is ruptured by the package rupturing mechanism, is aided by gravity.

Such an outflow of the concentrate, but also an effective operation of the package rupturing mechanism, then may be optimized when, in accordance with yet another embodiment of the assembly, the concentrate discharge channel and the package rupturing mechanism extends substantially vertically.

The package rupturing mechanism should be effective in rupturing the package, in one embodiment, without the need for excessive high pressures by the pressure element. For example such a package rupturing mechanism may comprise a knife (of which the cutting edge is directed towards the recess). In a very effective embodiment of such package rupturing mechanism the knife comprises two crossing knife blades. For example said crossing knife blades may define four inwardly inclined cutting edges for defining a central raised cutting point. Such a knife realises a cross-like cut with four flaps which easily open for the outflow of the concentrate.

In a very user-friendly embodiment of the assembly, the apparatus comprises a package loader for loading the package into the recess. Such a package loader is adapted to automatically position the package correctly in the recess. But also such a loader may be used for unloading or discharging a package when emptied by the pressure element.

For example, such package loader may comprise drive wheels for engaging the package. These drive wheels may be controlled by sensors sensing the presence of a package.

It is noted, however, that also manually loading the package into the recess is within the scope of the present invention. Likewise, other loader may be provided, for example a movable tray in accordance with a disc tray of a personal computer.

In yet another embodiment, the package is provided with markings, wherein the apparatus comprises a marking reader.

For example such markings and the marking reader-may cooperate for at least one of the following purposes: checking the correct position of the package in the recess and based thereon allowing or preventing the operation of the apparatus; checking the nature of the package and based thereon allowing or preventing the operation of the apparatus; providing information about the package and its contents (for example taste, mixing ratio, expiration date).

Checking the correct position of the package in the recess may be needed to avoid a malfunction of the apparatus (for example spilling concentrate). Checking the nature of the package also may comprise checking the origin of the package. When the package comes from a non-authorized source the reader may notify such to a controller which then prevents an operation of the apparatus. Providing information about the package may be helpful to a user of the package/apparatus.

For example the markings comprise, among others, any of: a bar code, rf-chip and a pattern of holes. Correspondingly, of course, the markings reader then may comprise a bar code reader, a rf-receiver, a hole pattern scanner, or alike.

For avoiding an outflow of concentrate other than through the concentrate discharge channel, the assembly may comprise a seal surrounding the concentrate discharge channel. Such a seal, e.g. a rubber ring encircling the mouth of the concentrate discharge channel, will effectively engage the package when latter is pressurized by the pressure element.

When, in accordance with another embodiment of the assembly, the recess and/or mixing chamber are defined in removable inserts of the apparatus, these parts can be removed easily for cleansing purposes (for which, moreover, it may be necessary that at least the mixing chamber may be opened for accessing its interior). It is noted that, basically, the recess and mixing chamber (and interconnecting concentrate discharge channel) are the only parts which will come in contact with the concentrate and thus are the only parts which need a thorough cleansing.

Secondly an aspect of the present invention relates to a package for use in the assembly.

Thirdly an aspect of the present invention relates to an apparatus for preparing a beverage in combination with a concentrate containing package.

### BRIEF DESCRIPTION OF THE DRAWINGS

Hereinafter the invention will be elucidated while referring to the drawings, in which

FIG. 1 shows, schematically, a top plan view of an embodiment of a package;

FIG. 2 shows, schematically, a partial top plan view of an embodiment of an apparatus;

FIG. 3 shows, schematically, a side elevational view of the apparatus of FIG. 2;

FIG. 4 shows a top plan view with the package partially received in the apparatus;

FIG. 5 shows a side elevational view of the situation according to FIG. 4;

FIG. 6 shows a top plan view with the package completely housed in the apparatus;

FIG. 7 shows a side elevational view of the situation of FIG. 6;

FIG. 8 shows a side elevational view corresponding to FIG. 7, however with the pressure means partially engaging the package;

FIG. 9 also shows a side elevational view corresponding to FIG. 7, however with the pressure means fully engaging the package;

FIG. 10 show a side elevational view corresponding to FIG. 7, after retraction of the pressure means;

FIG. 11 shows a top plan view of the package and apparatus during removal of the package from the apparatus, and

FIG. 12 shows a side elevational view of the situation of FIG. 11.

### DETAILED DESCRIPTION

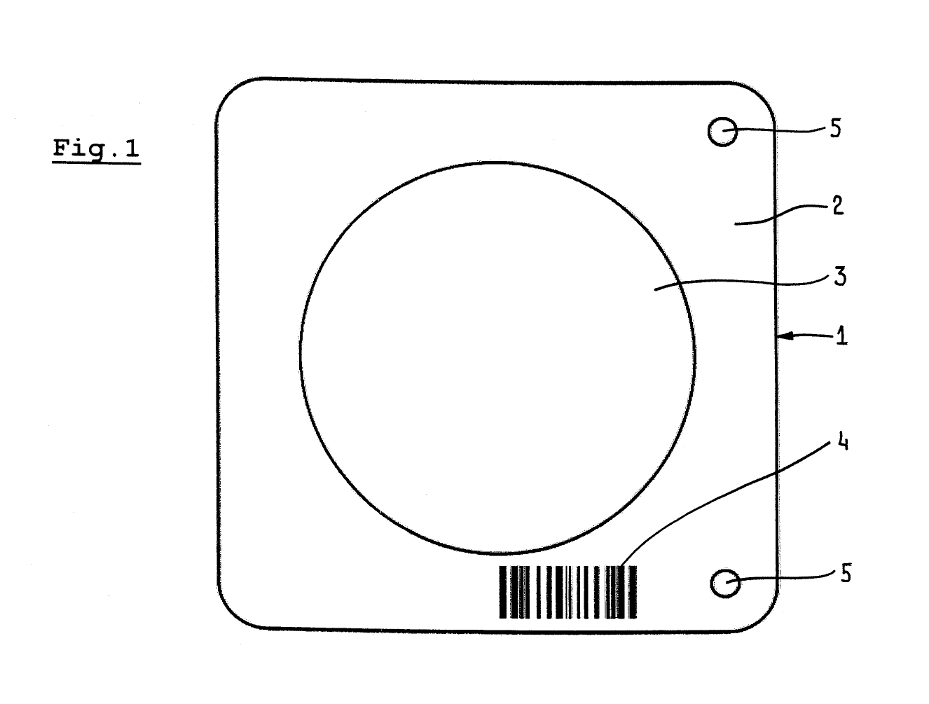

FIG. 1 shows a package which, in combination with an apparatus to be described hereafter, is used for preparing a beverage. In the illustrated embodiment the package is substantially rectangular or square having a circumferential sealing edge 2 and a central pouch 3 for receiving therein a concentrate for preparing a beverage. The package may be defined by two sheets of material sealed to each other at the sealing edge and defining between central parts the pouch 3. Further FIG. 1 illustrates a barcode 4 imprinted upon the sealing edge 2 and two holes 5 in the sealing edge 2.

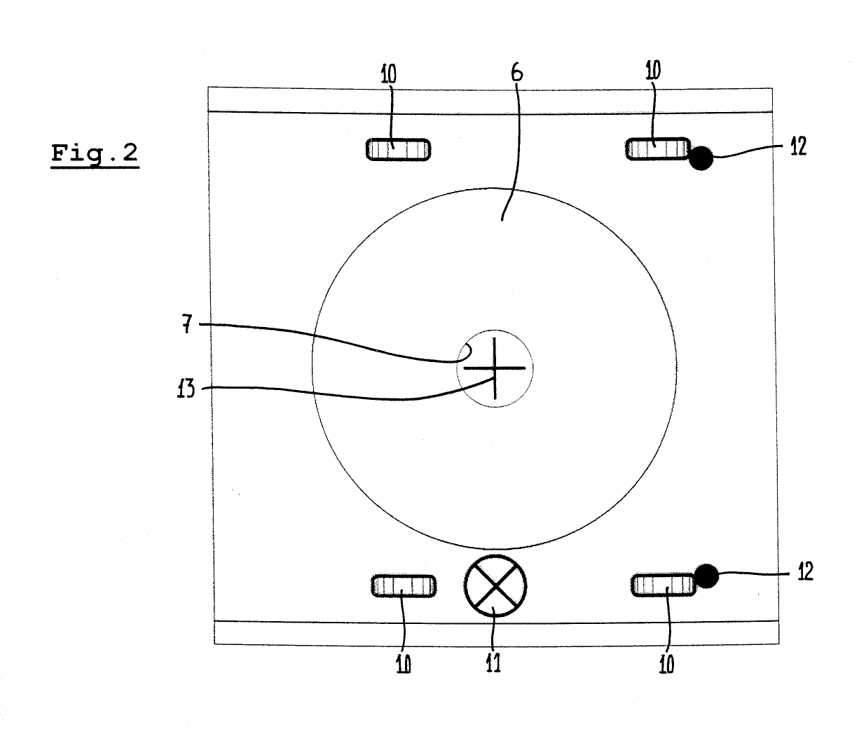

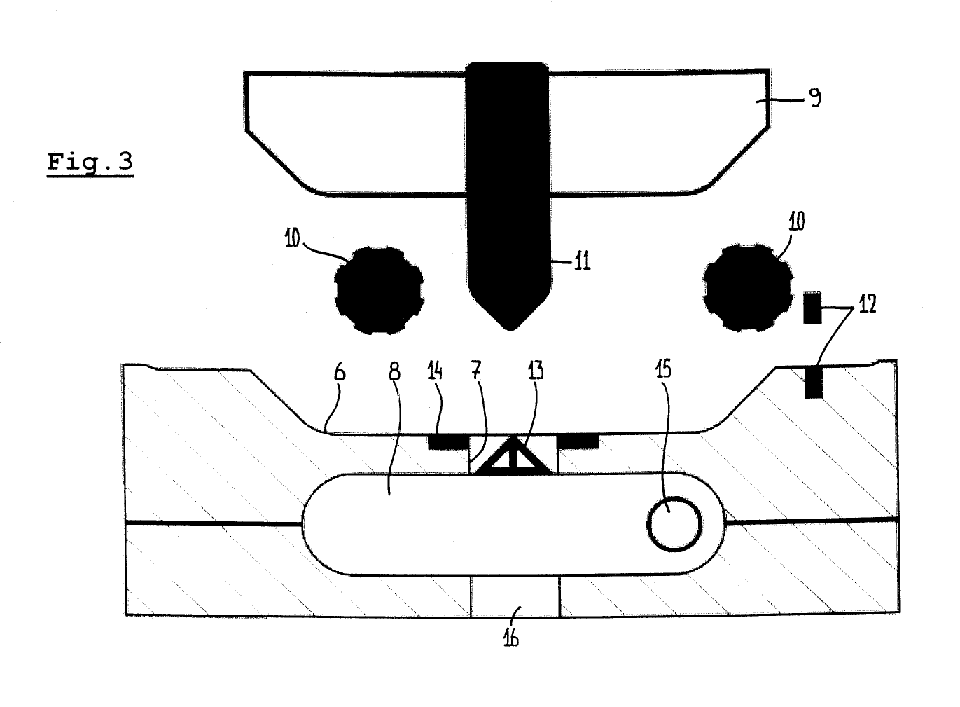

Referring to FIGS. 2 and 3, an apparatus for use with the package 1 is illustrated schematically. It is noted, that only those parts of the apparatus have been illustrated which are necessary for understanding aspects of the present invention. Other components (such as for example drive components for moving parts of the apparatus) have not been illustrated, but are within the reach of a person skilled in the pertinent art.

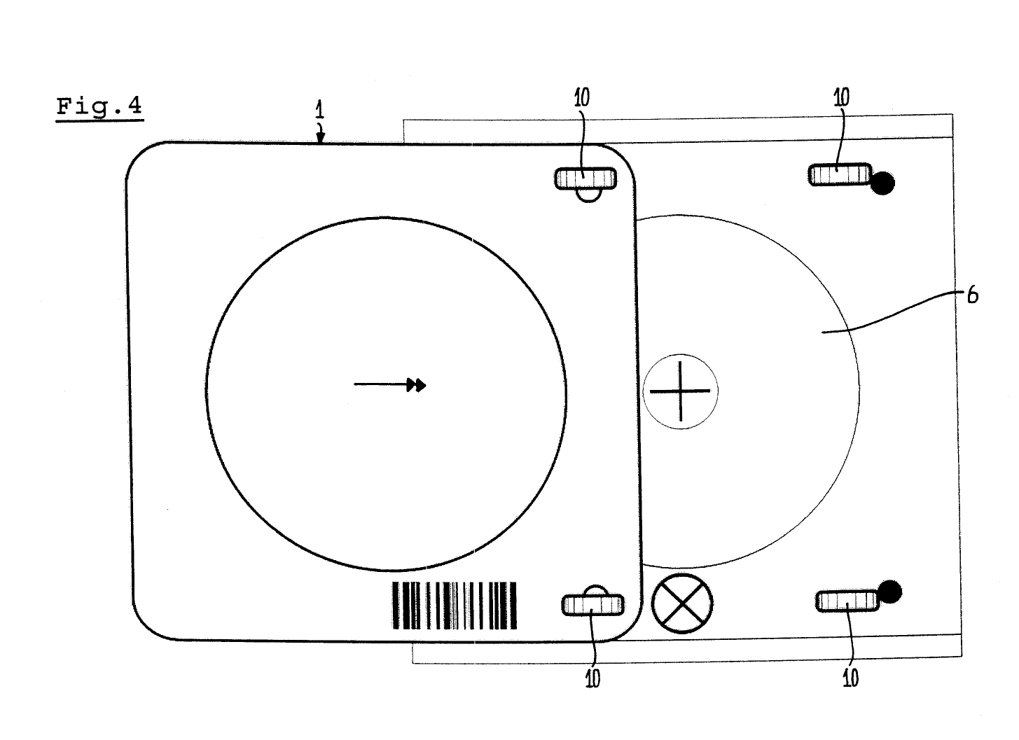

The apparatus comprises a recess 6 for at least partially receiving the package 1 (especially the pouch 3 of the package), a concentrate discharge channel 7 debouching in said recess 6 and connecting to a mixing chamber 8 and movable pressure element 9 for pressurizing the package. It is noted that said pressure element have not been illustrated in FIG. 2 or any other of the following top plan views (FIGS. 4,6,11).

Further loader 10 for loading the package 1 into the recess 6 (and unloading it therefrom) are provided, as well as a barcode reader 11 and scanner 12.

The shape of the recess 6 will be adopted to the shape of the (pouch 4 of the) package 1 in an unloaded rest position. Likewise the shape of the lower part of the pressure element 9 corresponds with the shape of the recess 6. The concentrate discharge channel is provided in a lower wall of the recess 6 and extends substantially vertically.

In the present embodiment, the loader 10 is shaped as toothed drive wheels for securely engaging the package 1, especially the sealing edge 2 thereof.

The bar code reader 11 will read the bar code 4 when the package 1 enters the recess 6. The scanner 12 will cooperate with the holes 5 in the sealing edge 2 of the package 1 to determine whether or not the package 1 is in a correct position.

Within the concentrate discharge channel 7 package rupturing mechanism 13 is positioned which, in the illustrated embodiment, is shaped as a knife comprising two crossing knife blades (see FIG. 2). This knife 13 is positioned such in the concentrate discharge channel 7 that it does not protrude into the recess 6 (see FIG. 3).

The apparatus operates in the following manner for preparing a beverage using the package 1:

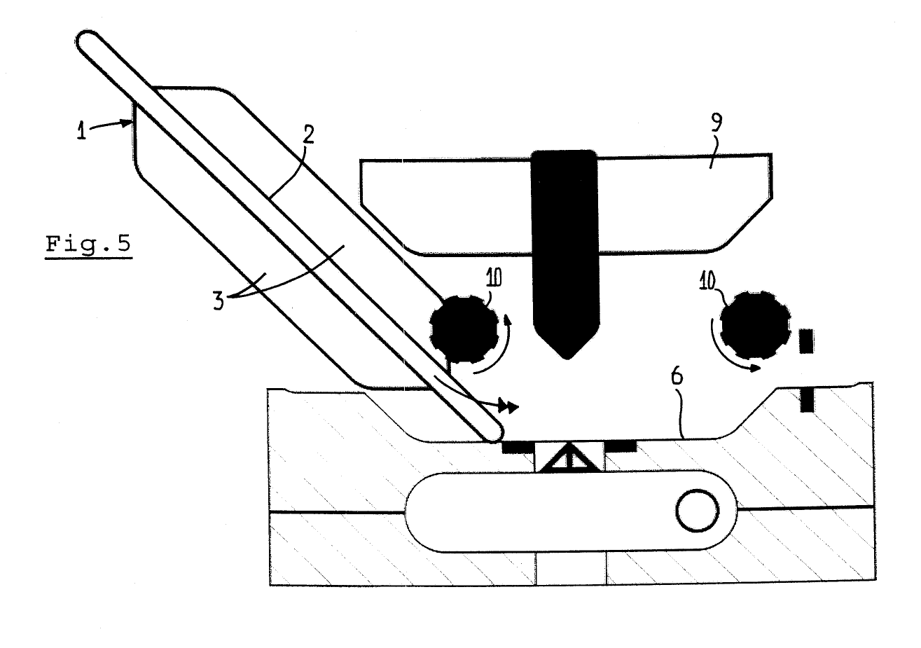

As illustrated in FIGS. 4 and 5 a package 1 enters the apparatus and is gripped by the drive wheels 10 which engage the sealing edge 2 of the package 1. Sensors (not illustrated) may be present to detect a package 1 and to automatically activate the drive wheels 10. The pressure element 9 (for example a die movable upwards and downwards by means of an appropriate a drive device not illustrated) is in an upper position.

Although, as illustrated, loading the package 1 into the recess 6 occurs automatically by means of the drive wheels 10, it also might be possible to use an embodiment in which the package 1 is positioned into the recess 6 manually.

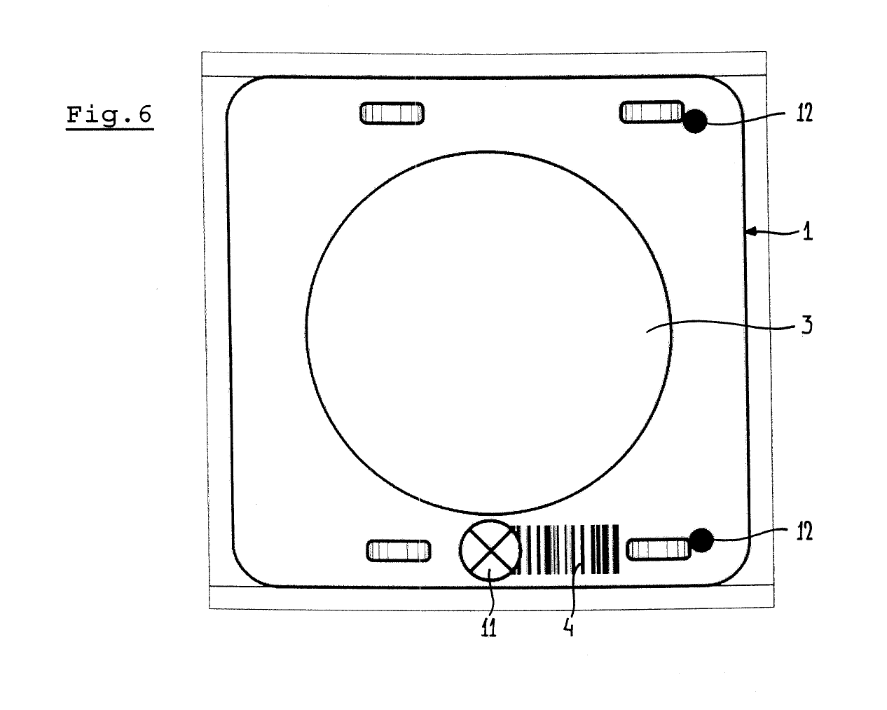

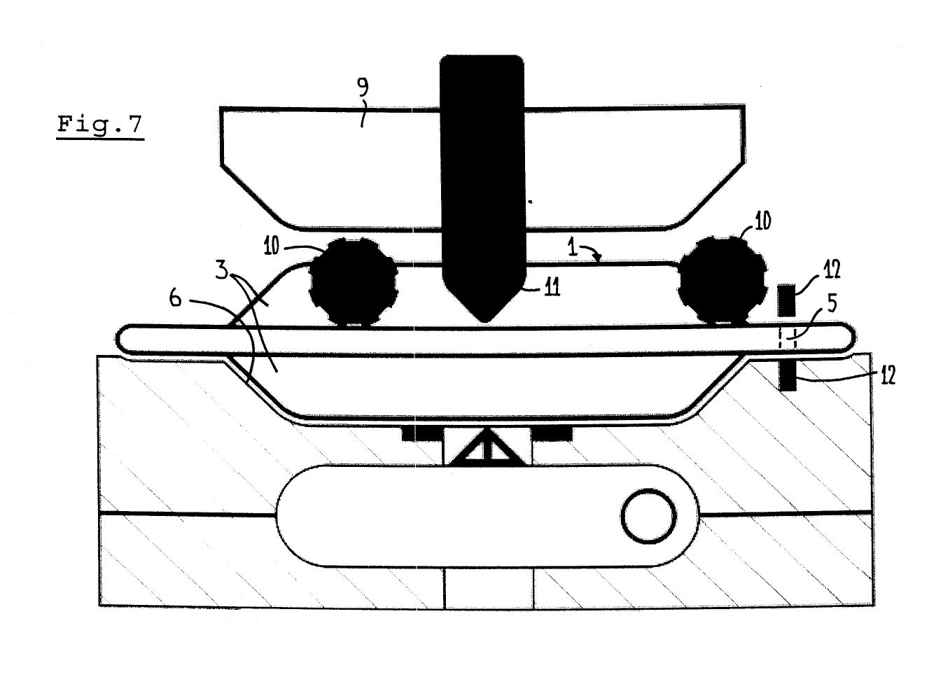

FIGS. 6 and 7 show a situation, in which the package 1 with its pouch 3 is positioned correctly in the recess 6. Such a correct positioning is determined by the scanner 12 which in such a correct position are aligned with the holes 5 in the sealing edge 2 of the package 1.

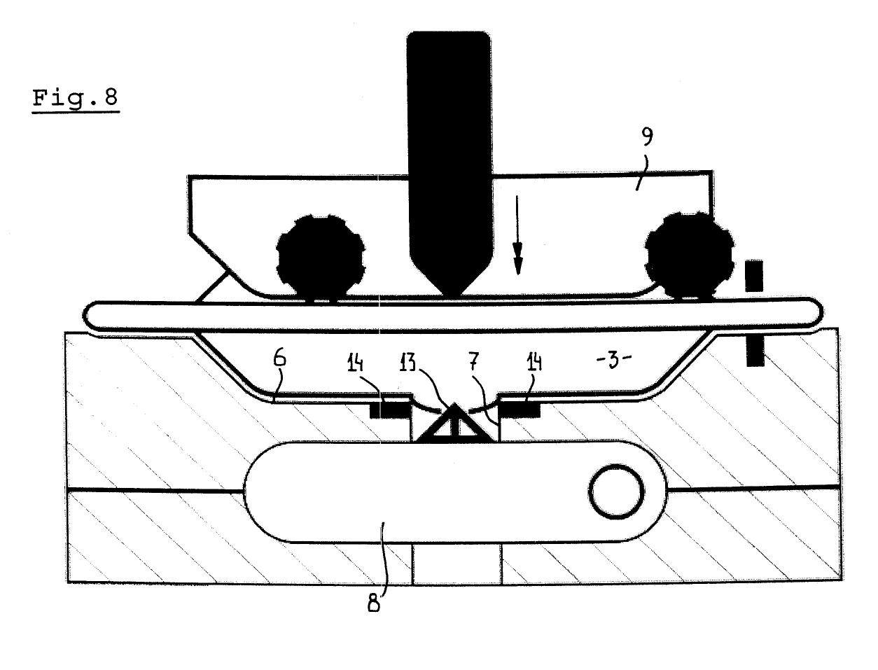

When such a correct positioning of the package 1 has been determined, the pressure element 9 is lowered, as illustrated in FIG. 8. As a result of lowering the pressure element 9, the package 1 is pressurized such that the part of the package 1 positioned just above the concentrate discharge channel 7 bulges out into this channel and engages knife 13. Thus knife 13 ruptures the package 1 and the contents thereof (concentrate) is free to flow into the concentrate discharge channel 7.

During this process a sealing means 14 (for example a rubber ring) surrounding the concentrate discharge channel 7 avoids that concentrate flow into the recess 6 instead of through the concentrate discharge channel 7.

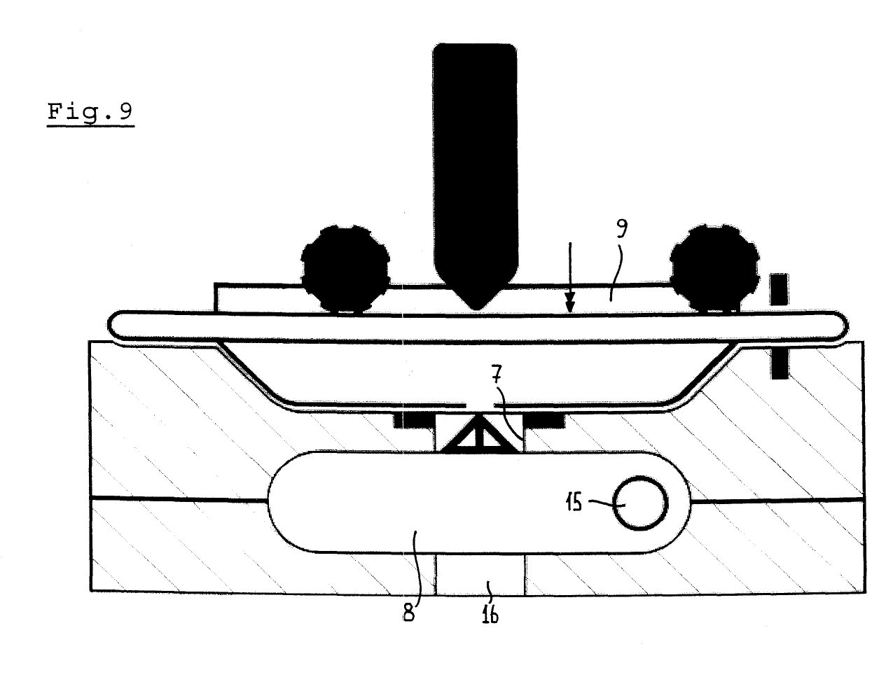

When the package 1 has been ruptured by the knife 13, a further downward movement of the pressure element 9 (FIG. 9) pushes the entire volume of concentrate out of the pouch 3 of the package 1 (the pouch is flattened), into the concentrate discharge channel 7 and towards the mixing chamber 8. An inlet 15 supplies water to the mixing chamber 8 such that the concentrate together with the water prepares the requested beverage which then leaves the mixing chamber 8 through an appropriate outlet 16.

The water may be supplied by the inlet 15 tangentially into the mixing chamber 8 creating a swirl for effectively mixing the concentrate with the water.

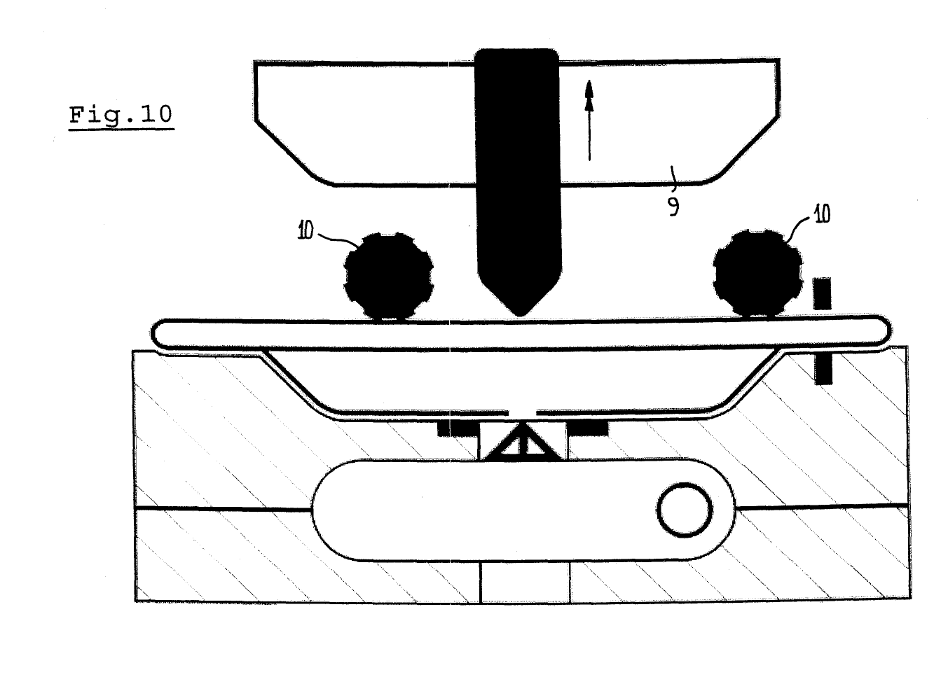

FIG. 10 shows a situation, in which the pouch 3 of the package 1 is fully emptied (and flattened) and in which the pressure element 9 is retracted upwardly.

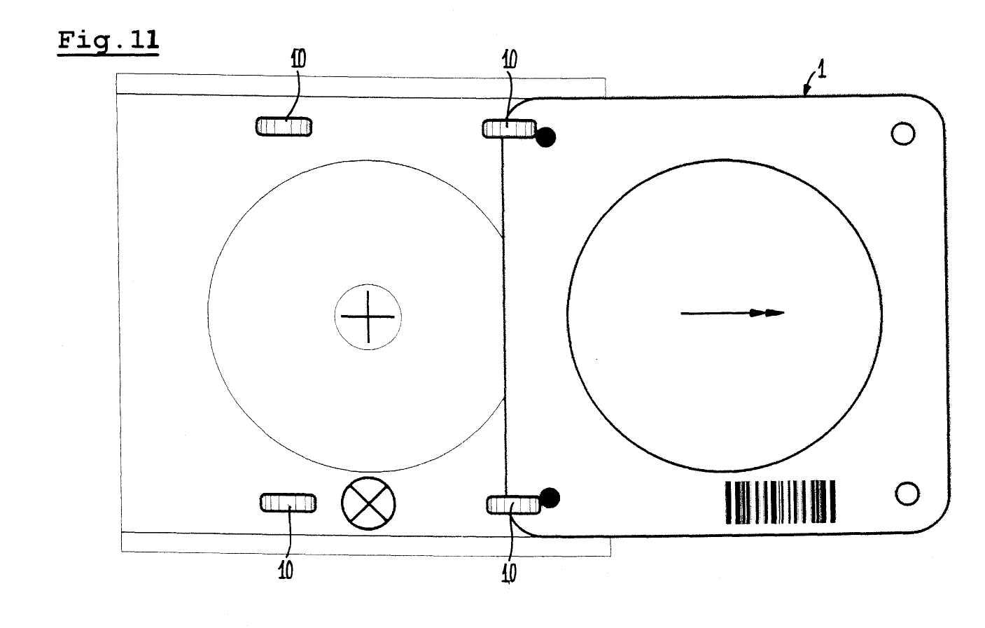

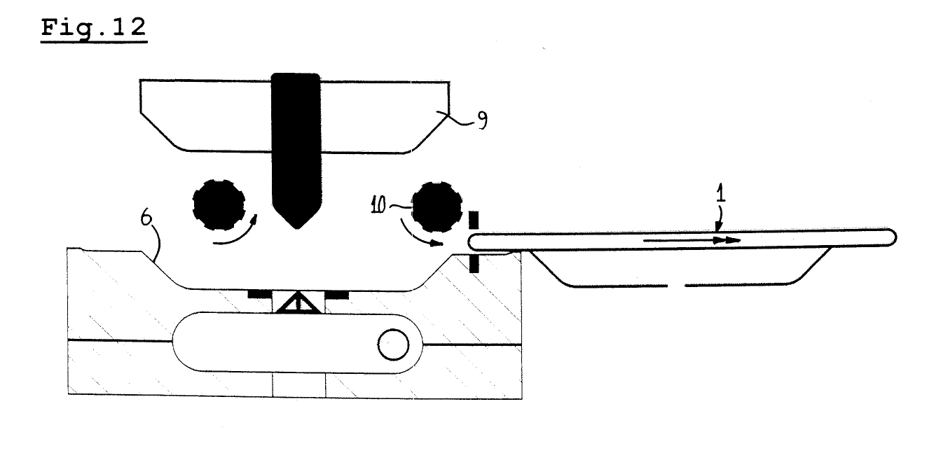

Finally, as illustrated in FIGS. 11 and 12, the drive wheels 10 are activated again and the empty package 1 is removed from the apparatus. The apparatus now is ready for receiving a next package 1.

Aspects of the invention are not limited to the embodiments described before, which may be varied widely within the scope of the invention as defined by the appending claims. For example, the apparatus may comprise a controller for enabling its operation (such as for example automatically activating the loader for loading and unloading the package, automatically activating the pressure means, etcetera).

1. An assembly for preparing a beverage, comprising a concentrate containing package and an apparatus for receiving the package and for preparing a beverage with the concentrate, wherein said apparatus comprises a recess for receiving said package, a concentrate discharge channel debauching in said recess and connecting to a mixing chamber, and a movable pressure element configured to pressurize the package, wherein a package rupturing mechanism is positioned in said concentrate discharge channel in a manner as not to protrude effectively into the recess and wherein the package is sufficiently flexible as to bulge out locally towards the concentrate discharge channel and into contact with the package rupturing mechanism when pressurized by the pressure element.

2. The assembly according according to claim 1, wherein the package rupturing mechanism do not protrude at all into the recess and wherein the package will bulge out into the concentrate discharge channel when pressurized by the pressure element.

3. The assembly according to claim 1, wherein the concentrate discharge channel is provided in a lower wall of the recess.

4. The assembly according to claim 3, wherein the concentrate discharge channel and the package rupturing means extend substantially vertically.

5. The assembly according to claim 1, wherein the package rupturing means comprise a knife.

6. The assembly according to claim 5, wherein the knife comprises two crossing knife blades.

7. The assembly according to claim 1, wherein the apparatus comprises package loading means for loading the package into the recess.

8. The assembly according to claim 7, wherein the package loading means comprise drive wheels for engaging the package.

9. The assembly according to claim 1, wherein the package is provided with markings and wherein the apparatus comprises markings reading means.

10. The assembly according to claim 9, wherein the markings and markings reading means cooperate for at least one of the following purposes: checking the correct position of the package in the recess and based thereon allowing or preventing the operation of the apparatus; checking the nature of the package and based thereon allowing or preventing the operation of the apparatus; providing information about the package and its contents (for example taste, mixing ratio, expiration date).

11. The assembly according to claim 9, wherein the markings comprise, among others, any of: a bar code, rf-chip and a pattern of holes.

12. The assembly according to claim 1, comprising sealing means surrounding the concentrate discharge channel.

13. The assembly according to claim 1, wherein the recess and/or mixing chamber are defined in removable inserts of the apparatus.

14. The assembly of claim 1 and a package for use in the assembly.

15. An apparatus for preparing a beverage using a concentrate containing package, comprising a support having a recess configured to receive a package, a concentrate discharge channel debouching in said recess and connecting to a mixing chamber, and movable pressure element for pressurizing the package, wherein a package rupturing mechanism is positioned in said concentrate discharge channel in a manner as not to protrude effectively into the recess.

16. The apparatus according to claim 15, wherein the package rupturing mechanism do not protrude at all into the recess.

17. The apparatus according to claim 15, wherein the concentrate discharge channel is provided in a lower wall of the recess.

18. The apparatus according to claim 17, wherein the concentrate discharge channel and the package rupturing mechanism extends substantially vertically.

19. The apparatus according to claim 15, wherein the package rupturing mechanism comprises a knife.

20. The apparatus according to claim 19, wherein the knife comprises two crossing knife blades.

21. The apparatus according to claim 15, comprising a loader configured to load the package into the recess.

22. The apparatus according to claim 21, wherein the loader comprises drive wheels configured to engage the package.

23. The apparatus according to claim 15, wherein the apparatus comprises a reader configured to read markings provided on the package.

24. The apparatus according to claim 23, wherein the reader is configured for at least one of the following purposes: checking the correct position of the package in the recess and based thereon allowing or preventing the operation of the apparatus; checking the nature of the package and based thereon allowing or preventing the operation of the apparatus; providing information about the package.

25. The apparatus according to claim 15, and further comprising a seal surrounding the concentrate discharge channel.

26. The apparatus according to claim 15, wherein the recess and/or mixing chamber are defined in removable inserts of the apparatus.
